(19) United States
(12) Patent Application Publication
(10) Pub. No.: US 2006/0224417 A1
(43) Pub. Date: Oct. 5, 2006

(54) Computer-implemented process for distributing and tracking pharmaceutical samples

(76) Inventor: Douglas J. Werner, Crystal Lake, IL (US)

Correspondence Address: DEWITT ROSS & STEVENS S.C., 8000 EXCELSIOR DR, SUITE 401, MADISON, WI, 53717-1914, US

(21) Appl. No.: 11/396,011

(22) Filed: Mar. 31, 2006

Related U.S. Application Data
(60) Provisional application No. 60/667,490, filed on Mar. 31, 2005.

(51) Int. Cl. G06Q 50/00; G06Q 10/00

(52) U.S. Cl. 705/2

(57) ABSTRACT

Described is a computer-implemented method for distributing and tracking free pharmaceutical samples. The method includes receiving at a Network Administrator a free drug sample data set for a free drug sample promotion program and transmitting the free drug sample data set received at the Network Administrator to a participating dispensary. The method also includes transmitting from the Network Administrator to a patient a unique alphanumeric identifier for the patient. A patient's prescription for a free drug sample is then filled at the participating dispensary. The participating dispensary (i) confirms the free drug data set transmitted by the Network Administrator and (ii) records a corresponding transaction data set comprising the patient's unique alphanumeric identifier, and identifiers for the type of free drug dispensed, the amount of free drug dispensed, and the date of dispensing the free drug. The corresponding transaction data set is then transmitted from the participating dispensary to the Network Administrator.

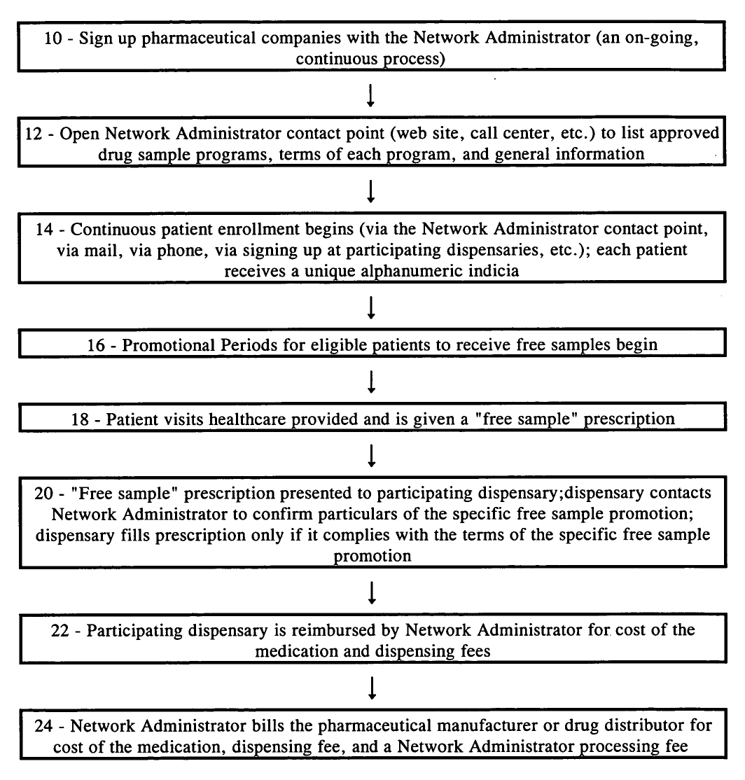

### CROSS-REFERENCE TO RELATED APPLICATIONS

Priority is hereby claimed to provisional application Ser. No. 60/667,490, filed Mar. 31, 2005, the content of which is incorporated herein.

### FIELD OF THE INVENTION

The invention is directed to a computer-implemented process for distributing and tracking pharmaceutical samples to individual, identifiable patients.

### BACKGROUND

Many doctors routinely distribute free samples of pharmaceutical drugs to their patients. These samples are provided free to the doctors by pharmaceutical companies. The doctors assume responsibility for storing and distributing the samples. The samples tend to be stored in relatively easily accessible places within doctors' offices. It is generally a low-priority, clerical chore within a busy doctor's office to keep track of these samples, i.e., to track how many samples have been dispensed and to whom (if tracked at all). Samples are also stolen or lost. Lack of suitable inventory controls results in a great many samples being wasted entirely because they are not dispensed prior to their expiration dates. This lack of control over the samples increases the risk of substance abuse and potential liability to doctors, clinics, hospitals, and the like.

Pharmaceutical manufacturers provide these free samples for doctors and patients as a trial to gather information regarding the use of the drug before the drugs must be purchased in the commercial markets. However, no organized method of distributing and tracking these samples currently exists. Each doctor's office and hospital has its own system, thereby creating inconsistencies and inefficiencies in the distribution of the drug samples. In addition, the lack of an organized system to track the distribution of drug samples makes it difficult or impossible to notify patients using these samples of problems, such as a drug recall or the potential for an adverse interaction with other types of medications.

Many hospitals and clinics require pharmaceutical samples to be closely monitored to maintain professional accreditation. Yet current methods to monitor the distribution of drug samples are inadequate, unreliable, and often simply not utilized (especially in the clinic and in doctors' offices). While certainly desiring to maximizing sales via drug sample promotions, pharmaceutical manufacturers also desire more systematic controls on the distribution of the free samples, both to comply with legislation such as the Prescription Drug Marketing Act (PDMA) and to limit their own liability. Therefore, a need exists for a organized system of tracking the inventory and distribution of pharmaceutical samples.

In the United States, the conventional provisioning of free drug samples to doctors is an enormous endeavor that is anything but “free.” The retail value of pharmaceutical samples distributed to doctors in the United States exceeds $10 billion annually. As briefly hinted at in the preceding paragraphs, the current drug sampling and distribution procedures are archaic and anything but systematic. In its crudest form, pharmaceutical representatives simply visit doctors' offices and clinics and leave the samples with the doctor, along with the prescribing information. These exchanges are often remarkably short meeting, lasting less than two (2) minutes. This is not exactly shocking, either to busy doctors or busy salespeople. Many times, samples are left without a face-to-face meeting between the sales representative and the provider. It is also unassailably true that a great many doctors perceive sales calls by pharmaceutical representatives as nothing more than an inconvenience. Thus many doctors' offices and clinics are simply closing their doors entirely to sales representatives.

Additionally, there has been at least one investigation by U.S. regulatory authorities (specifically the Department of Health and Human Services, Office of the Inspector General) delving into how drug samples are used to promote paid prescriptions for the sampled drug. Thus, to limit their legal liabilities, pharmaceutical companies must justify, in writing, how and why certain drug samples are supplied to doctors. Producing this documentation presents multiple problems, both clerical and legal, for the pharmaceutical companies. For example, the written records are subject to discovery in legal proceedings against the pharmaceutical company. On one hand, the documentation may very well evidence the good faith and good intentions of the pharmaceutical company in supplying the free samples. On the other hand, the documentation might also be cast in a false light to tarnish the motivations of the pharmaceutical company.

There are also very real dangers in supplying drug samples directly to doctors' offices and clinics without greater control over the ultimate fate of the samples. Sampled drugs run the gamut of the entire U.S. Pharmacopeia. The sampled drugs are almost exclusively available only with a prescription, and are thus inherently dangerous substances. Of particularly acute concern is that doctors' offices and clinics vary widely with respect to their internal controls. While the vast majority of doctors' office maintain strict access controls to their supplies of free drug samples, such access controls are by no means universal, even in big practices. Some doctors and clinics literally store their free drug samples in an unlocked closet. Access to the sample closet is open to anyone in the office. This creates a huge liability for both the doctor and the pharmaceutical company that supplies the free drug samples.

Some pharmaceutical companies have resorted to using vouchers or coupon-like trial cards, on a product-by-product, or offer-by-offer basis. Such “coupon” approaches, however, inconvenient for the doctors and pharmacies to use. Because the coupon-type promotions are on a product-by-product or offer-by-offer basis, each offer includes differing redemption procedures, and differing reimbursement instructions for pharmacies. Thus, as the number of “coupons” in circulation increases, the administrative details of properly processing the redeemed coupons becomes burdensome.

Some clinics are trying to track sample disbursements to comply with national guidelines administered by the Joint Commission on Accreditation of Healthcare Organizations (“JCAHO,” Oak Brook Terrace, Ill.). (The JCAHO is an independent, not-for-profit organization whose primary purpose is to provide voluntary accreditation of hospitals, clinics, nursing homes, and the like. The JCAHO was formed in 1951 by the American College of Physicians, the American Hospital Association, the American Medical Association, the Canadian Medical Association, and the American College of Surgeons. It is the preeminent hospital accreditation organization in North America.). Thus, for example, some clinics record the patient's name or file number in a log book, along with the particulars of the specific drug sample dispensed (e.g., product name, dose, lot number, and expiration date). But there is no universally excepted system for recording the information, or even for what information is recorded. The log books are therefore extremely unorganized.

The lack of systematic controls on the distribution of free drug samples makes any systematic follow up to the initial data recorded in the logs it difficult, if not impossible. For example, if lot numbers have not been recorded in the doctors' logs, or entered incorrectly, it is difficult or impossible to notify patients of a sample recall based on lot numbers. The only way then to notify patients of a recall is to contact every single patient who received a sample of the recalled drug. To deflect potential legal liability for this current state of affairs (and to save time), many clinics now require the sales representative to fill out stickers that include all of the above-noted info.

All of the above being noted, the greatest failure of drug product sampling in its current form is its inability to provide the healthcare industry with product-use or patient data. In short, samples are expensive to produce and distribute. The individual sample packages are very costly to produce as compared to the bulk quantities shipped to pharmacies. Shipping costs are also exorbitant. Free product samples are often shipped simultaneously to storage units maintained by the sales representative or directly to the providers' offices. Some companies only ship directly to the providers' offices. The samples must be maintained in temperature-controlled storage units, which further adds to costs. There is a cost associated with tracking and destroying (or returning) of outdated samples. These costs add up. Providing packaged drug samples accounts for approximately 30% of the promotional budgets of most large pharmaceutical companies. In most instances, this is the single largest expense item in the marketing budget. Yet, few product managers can assess accurately (if at all) its impact free product samples have on product inventory, consumer demand, prescription rates, or market shares. The bottom line is that pharmaceutical companies are spending a fortune to promote their products using free samples, yet these companies get very little actual market data in return for the amount of time and effort spent to fabricate and distribute free samples.

Pharmaceutical companies are also exposing themselves to considerable risk. In the litigious atmosphere in the United States, pharmaceutical companies have plenty to worry about just making sure their products are safe and effective. Passing muster before the Food & Drug Administration does not even shield companies from litigation. Merck & Co. voluntarily withdrew its Vioxx-brand pain reliever (rofecoxib) from the U.S. market in light of on-going studies that indicated the drug raised the risk of heart attack in certain patients. The action was lauded by then-Acting FDA Commissioner Dr. Lester M. Crawford: “Merck did the right thing by promptly reporting these findings to FDA and voluntarily withdrawing the product from the market.” See FDA Press Release P-04-95 (Sep. 30, 2004). Nevertheless, Merck & Co. currently faces thousands of contingent-fee product liability law suits, despite the fact that the FDA found the drug safe and effective and never demanded that Merck recall the drug.

This litigious milieu regarding the safety and efficacy of pharmaceutical products, is further complicated by the Prescription Drug Marketing Act (PDMA), which sets strict guidelines on how products are marketed. Even for drugs shown to be safe and effective by the FDA, violations of the PDMA can be tremendously costly. For example, TAP Pharmaceutical Products, Inc. agreed (in 2001) to pay $875 million to settle civil and criminal charges brought under the PDMA. Currently, many clinics and representatives are removing samples out of the packaging (a PDMA violation). Patients often do not get a package circular (also a PDMA violation). Adding a further layer of potential liability, not all samples have been stability tested with the samples being exposed to light. The samples are tested in their packaging, with the assumption being that the tablet or capsule will remain in the packaging until the moment before it is to be ingested. It is not uncommon for unauthorized people take samples for personal use without a prescription, or for “recreational” abuse.

Thus, to limit their legal liabilities, big pharmaceutical companies pay third parties to confirm the accuracy of receipts for free drug samples. All large-scale pharmaceutical companies also have entire internal departments whose sole duty is to administer the free product sampling promotions. For manufacturers and marketers, free drug sample promotions embody titanic effort, expense, and liability, but whose actual returns in prescriptions filled remains largely unknown.

The current free drug sample protocols also require significant time and effort on the part of the pharmaceutical sales force. For example, a field sales representative will spend, on average, about one (1) per day completing sample scan forms and computer entries. The representative will spend about two (2) hours every two months receiving and logging sample shipments. Roughly two (2) hours are spent every quarter completing an inventory. The time spent adds up to significant loss in selling time, and concomitant loss in revenue.

And unlike in days gone by, the offer of free samples no longer opens doctors' office doors automatically. The sales representative bearing free samples is no more likely to gain access to a doctor, nor more likely to spend a decent amount of time with the doctor, than any other sales representative. Free samples simply do not increase selling time: the average time a sales representative spends with a provider is only 60-90 seconds. Many “sample calls” (that is, sales calls where the representative has free product samples do distribute) do not automatically result in face-to-face time with the provider.

The return-on-investment of virtually all drug sample programs is low or entirely unknown. This is because there is virtually no control of how the samples are distributed once they leave the control of the sales representatives. Free drug samples are given to thousands of patients that never receive a full prescription. A study done by ImpactRx (a Mt. Laurel, New Jersey-based pharmaceutical sales data company) found that during the first six months of 2004, 60% of all drug samples were dispensed without a prescription. Many providers dispense samples to previously diagnosed patients with a renewal prescription. It is common for providers to give patients one (1) or two (2) months' worth of samples at one time. Samples are given out to thousands of patients who can't afford them; however most companies have a separate indigent patient program for these patients. Only about 25% of samples given out to newly diagnosed patients are accompanied by a prescription. Many of these patients who actually receive a prescription along with the free sample never fill the prescription.

In short, there are thus a host of reasons to rationalize the drug sample distribution process. Distributing drug samples under a systematic process can, for example, justify the magnitude of the sampling program budget. Systematic control can reduce overall sampling costs. A feedback mechanism can make drug companies be more responsive to physician demand. A rational drug sampling process frees up representatives so that they have more quality selling time. The ability to track and report drug sample use decreases PDMA liability and JACHO liability. And lastly, the return-on-investment of the conventional drug sampling approach is so poorly understood that forward-thinking companies should be willing to walk away from the costs and liabilities inherent in an uncontrolled system, to a new system that embraces accountability and a very clear return-on-investment. There remains a long-felt and unmet need to leverage the power of free sample programs both to increase pharmaceutical sales and to decrease marketing liability issues.

### SUMMARY

The invention relates to a novel national (or regional) process for distributing and tracking free pharmaceutical samples. The process includes having pharmaceutical manufacturers interested in a systematic method for distributing and tracking their samples to agree to participate in the program. Patients interested in receiving free drug samples then register for a free drug sample number, usually printed or encoded on a card (such as a conventional and well-known credit card, gift card, insurance card, etc.). The card is not required, but it is convenient. Each sample card includes unique alphanumeric indicia that uniquely identifies the holder of the card (i.e., the patient). Doctors or nurse-practioners (hereinafter “providers”) then prescribe the free drug samples as they would any other prescription medication. The patients then present the prescription, along with sample card at any participating dispensary, such as a pharmacy, clinic, or hospital, to receive their free drug samples.

The dispensary notes the sample card number, and the particulars of the drug sample prescribed (e.g., type of drug, dosage, dosage form, number of tablets, lot number, expiration date, date of dispensing the precription), and reports this information to a program administrator (designated herein as the Network Administrator). Participating drug manufacturers (or program underwriters) pay the Network Administrator a fee to cover the costs of the medication itself, as well as the pharmacy effort needed to dispense the samples, claims processing fees, and to process the resulting stream of data (which is a correlated stream of patients' names and drug samples dispensed). The Network Administrator may optionally reimburse the participating dispensaries for the costs of carrying the drug samples in inventory, dispensing the samples, and transmitting the relevant information back to the Network Administrator. (In the preferred version, however, the pharmacies would be dispensing the free samples from their existing stock.)

Manufacturers and distributors participating in the process may specify the dose, quantity, and dosage form (e.g., liquid, tablets, capsules, etc.) of each sample to be distributed. The manufacturers may also determine the length of time each sample is to be distributed. For instance, the free samples may be restricted to one free sample, one free sample every 3 months, one free sample as needed for one year, etc. The manufacturers can dictate the desired terms of the sample program. However, the terms of the agreement generally require the manufacturers to pay the Network Administrator a dispensing fee, the cost of the medication, and a processing fee. In return, the pharmaceutical manufacturers receive an organized, national (or regional) process for distributing and tracking the free samples. With permission from the patients, the manufacturers (i.e., underwriters) may also be authorized to contact users of the free samples directly (to learn more about effectiveness, side effects, enroll patients in patient education programs, etc.).

The alphnumeric indicia unique to each patient at a minimum identifies the name of the patient. The alphanumeric indicia may also be matched with or encode other relevant patient information such as allergies or illnesses, age, sex, genotype characteristics, etc. By registering for an alphanumeric indicia, the patient can receive free pharmaceutical samples from participating pharmacies.

Registration is preferably organized at the national level (although any other smaller level, e.g., state, county, municipal, etc. can also be used) and can be completed in any number of ways. Using the Internet, a patient can visit a website maintained by the Network Administrator and fill out the required information. Registration can also be done by mail, by filling out enrollment forms distributed by participating doctors and hospitals, or by phone, etc. Patients interested in the free sample program can register for a card at participating pharmacies. In short, enrollment may be accomplished by any means now known or developed in the future for gather such information.

In the preferred version of the invention, the Network Administrator assembles and maintains a database of all of the data gathered under the free sample process. This database is preferably made accessible to pharmaceutical manufacturers. The database so assembled can then be used as a clearinghouse of information pertaining to the sample program. For instance, manufacturers, physicians, pharmacists, and/or patients could access the current information available regarding distribution of a specific sample, or view a list of drugs that are available through the free sample program. (Access to the database is preferably provided via the Internet.) Updated periodically, and preferably in real time, users of the system can receive immediate feedback on of the popularity of a specific drug and quickly learn of any patient complaints or problems. The Network Administrator may also, for a service fee, provide specific prescription data to the manufacturers on a regular basis. Further, patients could access the database to learn more about the pharmaceutical samples they are using, e.g., product label information, additional indications, contra-indications, potential adverse drug interactions, etc. Links could be provided to the manufacturers' websites. Other products may be advertised on the Network Administrator's web site.

In use, a doctor writes a prescription for a specific free drug sample, in the exact same fashion as any other prescription, with the exception that the prescription indicates “free sample” or any other suitable indicator that the prescription is for a free sample of the indicated drug. Ideally, the prescription will include the word “sample,” i.e., “Sample of Effexor XR 75 mg.” The patient then takes this prescription to any participating dispensary, where the dispensary records the patient's sample card number and distributes the sample. The pharmacy then transmits the transaction information to the Network Administrator (optionally along with any complaints or problems noted). In this way, a national tracking system for the distribution of free samples is provided.

By adhering to this program, hospitals and individual doctors will no longer be responsible for controlling large supplies of free samples. This will ease compliance with the requirements of the Joint Commission on Accreditation of Healthcare Organizations (JCAHO), an important policy consideration for many hospitals. Storage space once reserved for the free samples will be freed for use by other supplies. Further, doctors will experience increased productivity by not having to sign for (and thus take responsibility for) a rolling inventory of drug samples. Instead, pharmacies and other dispensaries will promote the free samples out of their existing store inventory. Dispensaries are already equipped with sophisticated inventory tracking controls, thus the process does not foist added burdens upon the dispensaries. Further, it will limit the expense of destroying outdated samples. In short, the subject process maximizes the efficiency of delivering free drug samples to patients (to the benefit of all participating parties: patients, doctors, dispensaries, and manufacturers).

Participating manufacturers benefit from the process due to the economies of scale generated by a national (or region) program. By keeping tighter controls on the distribution of the samples, less samples will be wasted, saving on resupply costs. Storage fees and shipping fees are also vastly reduced because there are far fewer dispensaries than there are doctors' offices. Further, because pharmacies maintain a tight control on their inventories, less samples will be returned to manufacturers because they are outdated or require changes in the package insert. Additionally, the process gives the manufacturers the power to determine the quantity of free samples to be distributed for each promotion. Because of lax controls, many physicians currently abuse free drug sample promotions (either intentionally or through benign neglect) by prescribing months' worth of free samples to patients, even though the promotion requires a far shorter duration.

The process will also increase manufacturers' compliance with the Prescription Drug Marketing Act (PDMA), a growing priority of drug manufacturers. Manufacturers will face less liability by having the pharmacist control distribution of the samples, rather than physicians directly.

Patients also benefit from using this process. A pharmacist can screen for adverse drug interactions. Additionally, because of the tight inventor controls at pharmacies, patients would not have to worry about whether their clinic or pharmacy has their free sample in stock. As manufacturers only need to stock one dispensary to serve, for example, a local retail pharmacy, a larger variety of free drug samples may be provided.

The many benefits of the present invention will increase as more manufacturers, hospitals, doctors, and pharmacies agree to participate. Until legislation is passed that mandates more strict monitoring of pharmaceutical samples, the above-described process would, of course, be voluntary. However, the costs of the process for patients, hospitals, doctors, manufacturers and pharmacies are far outweighed by the benefits in decreased risk exposure and increased efficiencies of scale. Of particular note for patients themselves, the invention allows them to receive free samples of different drugs, from different manufacturers, using only a single identifier. The patient is not assigned a new identifier for each free drug sample. Instead, in the present invention, each patient uses his or her own unique identifier for any and all free drug sample promoted according to the present invention.

### BRIEF DESCRIPTION OF THE FIGURE

The sole drawing is a flow chart illustrating the preferred version of the present invention.

### DETAILED DESCRIPTION OF THE INVENTION

A used herein, the term “computer” means any type of electronic data processor of any description, including microprocessors, desktop computers acting alone or in arrays, and mainframe computers. “Computer-implemented” as applied to a process indicates that the one or more steps of the process are accomplished using a computer.

As used herein, the term “database” means a collection of information stored in a computer in a systematic way, such that a computer program can consult the database (i.e., the database can be queried) to answer questions. The software used to manage and query a database is generally known as a database management system (DBMS). A host of database management systems are known in the art and will not be discussed in any detail herein. Database management systems, from the straightforward to the mind-dazzlingly complex, are available from worldwide commercial suppliers such as Microsoft, Oracle, Novell, Apple, and SAP.

“Correlating” as used herein means matching, linking, or otherwise associating alphanumeric indicia, identifiers, and data sets with one another using user-defined parameters.

“Transmitting,” as applied to data, indicia, identifiers, or any other type of information, means conveying the information, or making the information accessible, from one location to another via any means now known in the art or developed in the future, without exception and without limitation. Means for transmitting information include (without limitation) telephone, telegraph, facsimile, radio, private computer network, public computer network, global computer network, local-area computer networks (LAN), wide-area computer networks (WAN), the Internet, etc.

The term “payment” as used herein means the exchange or transfer of anything of value or potential value, without limitation. “Payment” includes (without limitation) the exchange or transfer of goods, services, cash, credit, debt, securities, debt instruments, liabilities, accounts receivables, accounts payables, and the like.

The present invention is a computer-implemented method for distributing and tracking free pharmaceutical samples. The preferred version of the method comprises receiving at a Network Administrator a host of free drug sample data sets from different pharmaceutical manufacturers, wholesalers, distributors, etc. (generically referred to herein as “undewriters”). The free drug sample data sets comprise identifiers for the type of drug, the dose, the quantity, the frequency, and the program duration for a free drug sample promotion program. The invention also includes transmitting from the Network Administrator to a patient a unique alphanumeric identifier for the patient. The unique alphanumeric identifier allows the Network Administrator to correlate which free samples are given to which patients. The free drug sample data set received at the Network Administrator is transmitted to (or made accessible to) a participating dispensary. A patient's prescription for a free drug sample is then filled at the participating dispensary. The participating dispensary confirms the free drug data set transmitted by the Network Administrator; and records a corresponding transaction data set comprising the patient's unique alphanumeric identifier, and identifiers for the type of free drug dispensed, the amount of the free drug dispensed, and the date of dispensing the free drug. The corresponding transaction data set is then transmitted from the participating dispensary to the Network Administrator.

The Network Administrator may then compile a computer database containing the drug sample data set and the corresponding transaction data set. The Network Administrator, using a programmable computer, may correlate the identifiers contained in the drug sample data set and in the corresponding transaction data set, using any desired parameter included within either of the two data sets (e.g., drug type, amount, sex of patient, age of patient, geographic location of patient, etc.)

As noted above, the information manipulated during the process may be received, transmitted, or otherwise made accessible to the various parties via any type of communication structure or means now known or developed in the future, including, without limitation, telephone, telegraph, facsimile, global computer network, Internet, wide-area computer network, local-area computer network, electronic mail, and postal delivery.

In the preferred version of the invention, payment is transmitted on behalf of the Network Administrator (either from the Network Administrator directly or from the Administrator's designee) to the participating dispensary for: (i) the cost of the free drug sample dispensed, and (ii) a dispensing fee charged by the participating dispensary for its services in delivering the free sample to the patient. The preferred version also includes transmitting payment on behalf of an entity underwriting the free drug sample promotion program to the Network Administrator for: (i) the cost of the free drug sample dispensed, (ii) the dispensing fee charged by the participating dispensary, and (iii) a Network Administrator processing fee.

Also in the preferred version, before the prescription is filled, the participating dispensary verifies that the patient whose prescription is to be filled meets eligibility requirements contained within the free drug data set. In this fashion, drug manufacturers and distributors can be sure that the free samples are being dispensed only to those patients qualified to receive the free samples (and actually in need of the drug being dispensed).

In the preferred version of the invention, which is shown in flow-chart form in the sole drawing FIGURE, a national sample program is implemented to dispense and track samples. Samples are dispensed and tracked (preferably through a National Sample Card program administered by a centralized Network Administrator). In this version of the invention, pharmaceutical companies (or any other free drug sample program underwriters) sign up or otherwise enroll with the Network Administrator (10) and transmit to, or provide to, the Network Administrator a free drug sample data set that outlines the parameters of the free drug promotion. Generally speaking, the free drug sample data set comprises, at a minium, identifiers for type of drug, dose, quantity, frequency, and program duration for the free drug sample promotion program. The free drug sample data set may also include any other data or identifiers deemed suitable or desirable by the program underwriter.

The Network Administrator provides a point of contact (12) for underwriters and participating dispensaries to exchange information with each other.

Patient enrollment (14) then begins. Each patient is provided with a single unique alphanumeric indicia that allows patients to receive free drug samples from multiple manufacturers. Each individual is assigned a single, unique alpha numeric identifier. The Network Administrator may require that each patient provide a wide range of personal information (name, date of birth, contact information, social security number, gender, marital status, other medications taken, name of primary physician, etc.) before a unique alphanumeric indicia is assigned to that patient. The free drug sample promotion then begins (16).

In the present invention, the drugs samples themselves are delivered from the manufacturer, to a participating dispensary (i.e., a participating pharmacy) and the samples are dispensed to the patients via the pharmacies (20), not doctors' offices or clinics. The program is free of charge for all patients (preferably nation- or even world-wide). To receive the free sample, the physician simply indicates on the prescription itself that it is a “free sample” prescription (18). The pharmacy then fills the prescription as a free sample and transmits the transaction data set to the Network Administrator. A patient does not need to present a voucher or a specific drug card that is unique to any one manufacturer or product. The single unique alphanumeric identifier is good for any and all free drug sample promotions being handled by the Network Administrator.

To continue therapy with the drug, a patient simply phones the pharmacy or doctor and requests a refill. The refill may again be free, or the refill may be sold at full price, or the refill may be sold at a reduced price).

To enter the program and receive an identifying alphanumeric indicia the patient must register (14), preferably in advance, with the Network Administrator. As noted above, this can be done by any convenient method: web registration, phone registration, mail registration (enrollment forms could be distributed by participating manufacturer's representatives at clinics and pharmacies); pharmacy registration; pre-printed cards or temporary cards with unique alpha-numeric indicia could be available at clinics and pharmacies with activation occurring via the pharmacy, phone, and/or internet; Tear-off sheets with all the program information printed on it.

The unique alphanumeric indicia for each patient can be as simple as the patient's social security number. Using the pateints' social security numbers, however, could prove troublesome for younger patients (many of whom do not yet have a social security number) and undocumented immigrants. Any unique identifiers can be used.

In the preferred embodiment, the invention is implemented on a national, or at least regional regional scale. Manufacturers would sign an agreement to participate in the drug sample program. The agreement between the Network Administrator and the pharmaceutical manufacturer or distributor preferably specifies the product to be distributed, the dose, the quantity, and the financial obligation required to pay for the dispensing fee, the cost of the medication, and the processing fees; see (22) and (24) in the FIGURE. The sample promotion conditions may be set by each manufacturer negotiating with the Network Administrator, or a set of standard contractual provisions could be implemented by the Network Administrator so that all manufacturers could access the program on identical terms. As noted above, manufacturers would have unfettered ability to dictate the substantive terms of each offering; e.g., the time duration, the total amount of drug to be distributed and to whom, geographic restrictions (e.g., a given promotion might only be offered at pharmacies located within a given region), etc.

In the preferred embodiment, a list of available products available as free samples (similar to a formulary) would be made available to physicians and to pharmacies (12). This information could optionally be made available to patients, although advance knowledge of the free sample promotions might enable the unscrupulous to abuse the system.

There are many benefits to the present invention. First, it greatly increases the return-on-investment. Because the patient must enter the pharmacy to get the free sample in the first place, and again if the sample is to be refilled, it increases the likelihood that a full prescription will be filled following the consumption of the sample trial. By querying the database maintained by the Network Administrator, Product managers can assess the impact of any given free drug promotion on product inventories, consumer demand, prescription rates, and market shares.

Of perhaps critical importance, the pharmaceutical companies will know exactly who is prescribing their samples and whether or not a prescription will follow the free trial. Each alphanumeric indicia is matched to a patient name. If that patient then fills a paid prescription, the manufacturer can match that prescription to the transaction data obtained from the Network Administrator.

The entire drug sampling process is fundamentally altered by having a central Network Administrator handle product distribution and tracking. Sample trial conditions can now be set and actually enforced by each manufacturer. Manufacturers can set specific regulations as to who is eligible to receive a free sample. Manufacturers can set and enforce trial quantities. None of these goals can be accomplished in the conventional free drug sample system.

The invention also greatly reduces costs. Shipping expenditures are vastly reduced because the samples would be dispensed from the pharmacies' normal stocks of the medications. Storage unit expenditures for sales representatives would be eliminated, as would almost all special packaging expenses. Less samples will be disbursed as a result of tight controls over quantities distributed to patients. Physicians are simply not able to dispense months' worth of free samples using the present invention because the physician does not have possession of the sample at all. If the physician writes a sample prescription for a month's worth of drug, but the program rules specify only one week's worth, that information will be revealed when the pharmacist attempts to fill the prescription. The prescription will be filled according to the terms set forth by the manufacturer, or the prescription will not be filled at all.

The invention also eliminates returns of samples that have reached their expiration dates. The pharmacies would simply dispose of their outdated stocks according to their convention protocols and well-known protocols.

The present invention also increases the productivity of sales representatives. In short, the sales force can devote more time to selling, rather than committing precious time to record, track, store, and deliver samples. It also eliminates entirely the need to monitor pharmaceutical representatives when they are actually delivering samples. Pilfering of samples for “recreational” abuse or illegal resale has been known to occur among pharmaceutical representatives.

The sales representatives also decrease their exposure to sensitive patient information (information that they do not need to do their jobs). Once implemented, neither the representatives nor the doctors need to set aside storage space for storing samples. The free samples are shipped directly to the participating dispensaries, rather than to doctors' offices and to sales representatives. With the present invention in place, neither doctors nor representative have to manage and account for disposal of outdated samples.

Of notable benefit for the participating dispensaries, the invention disclosed and claimed herein requires patients to go a participating dispensary to get the free drug sample. In short, the invention steers more patients into pharmacies. More patients coming in the door directly translates into more potential sales for the pharmacy (impulse purchases and otherwise). For patients taking more than one prescription medication, the need to go to the pharmacy to receive the free sample also presents an opportunity for the pharmacy to fill the patient's other prescriptions too. Thus the invention creates substantial increases in revenue from a new source of business.

The present invention also has benefits for the patients. Most notably, the patients receive free drugs. They also get face-to-face time with a pharmacist, an increasingly rare phenomenon in an age of increasing deliveries of pharmaceutical via mail order. The patient-pharmacist interaction is critical for discovering adverse drug interactions, allergies, side-effects of medications, etc. It also ensures that the medication is delivered in conjunction with the proper labeling. Because the free sample is dispensed pursuant to a prescription, the invention enables prompt notification of patients who received free drug samples in the event of a product recall. This can be done using a pharmacy's existing database management systems. The prescription transaction data received by the Network Administrator could also be sold back to manufacturers to show prescription trends for their own products, as well as competing products. The return of data to the program underwriter may also be provided as part of the services the Network Administrator in exchange for its processing fee. This market data is an extremely valuable commodity that serves to encourage manufacturer and underwriter participation.

The description set out above is merely of exemplary preferred versions of the invention, and it is contemplated that numerous additions and modifications can be made. These examples should not be construed as describing the only possible versions of the invention, and the true scope of the invention will be defined by the claims included herein.

What is claimed is:

1. A computer-implemented method for distributing and tracking free pharmaceutical samples, the method comprising
(a) receiving at a Network Administrator free drug sample data sets comprising identifiers for type of drug, dose, quantity, frequency, and program duration for free drug sample promotion programs from a plurality of different underwriters;
(b) transmitting from the Network Administrator to a patient a unique alphanumeric identifier for the patient;
(c) transmitting the free drug sample data sets received at the Network Administrator to a participating dispensary;
(d) filling at the participating dispensary a patient's prescription for any free drug sample being offered under one of the free drug sample promotion programs of step (a), wherein the participating dispensary
(i) confirms the free drug data set transmitted by the Network Administrator; and
(ii) records a corresponding transaction data set comprising the patient's unique alphanumeric identifier, and identifiers for type of free drug dispensed, amount of free drug dispensed, and date of dispensing the free drug; and
(e) transmitting the corresponding transaction data set from the participating dispensary to the Network Administrator, wherein the patient's unique alphanumeric identifier remains unchanged for all of the patient's prescriptions.

2. The method of claim 1, further comprising: (f) correlating by the Network Administrator, using a programmable computer, the drug sample data sets and the corresponding transaction data sets.

3. The method of claim 1, wherein step (a) comprises receiving via a communication structure selected from the group consisting of telephone, telegraph, facsimile, global computer network, Internet, wide-area computer network, local-area computer network, electronic mail, and postal delivery; and steps (b), (c), and (e) comprise transmitting via a communication structure selected from the group consisting of telephone, telegraph, facsimile, global computer network, Internet, wide-area computer network, local-area computer network, electronic mail, and postal delivery.

4. The method of claim 1, wherein step (a) comprises receiving via Internet or eMail; and steps (b), (c), and (e) comprise transmitting via Internet or eMail.

5. The method of claim 4, wherein step (a) comprises receiving via Internet; and steps (b), (c), and (e) comprise transmitting via Internet.

6. The method of claim 1, further comprising (f) transmitting payment on behalf of the Network Administrator to the participating dispensary for (i) cost of the free drug sample dispensed, and (ii) a dispensing fee.

7. The method of claim 6, further comprising (g) transmitting payment on behalf of an entity underwriting the free drug sample promotion program to the Network Administrator for (i) the cost of the free drug sample dispensed, (ii) the dispensing fee, and (iii) a Network Administrator processing fee.

8. The method of claim 1, wherein in step (d)(i) the participating dispensary verifies that the patient whose prescription is to be filled meets eligibility requirements contained within the free drug data set.

9. A computer-implemented method for distributing and tracking free pharmaceutical samples, the method comprising
(a) receiving at a Network Administrator free drug sample data sets comprising identifiers for type of drug, dose, quantity, frequency, and program duration for free drug sample promotion programs from a plurality of different underwriters;
(b) transmitting from the Network Administrator to a patient a unique alphanumeric identifier for the patient;
(c) transmitting the free drug sample data sets received at the Network Administrator to a participating dispensary;
(d) filling at the participating dispensary a patient's prescription for any free drug sample being offered under one of the free drug sample promotion programs of step (a), wherein the participating dispensary
(i) confirms the free drug data set transmitted by the Network Administrator; and
(ii) records a corresponding transaction data set comprising the patient's unique alphanumeric identifier, and identifiers for type of free drug dispensed, amount of free drug dispensed, and date of dispensing the free drug;
(e) transmitting the corresponding transaction data set from the participating dispensary to the Network Administrator, wherein the patient's unique alphanumeric identifier remains unchanged for all of the patient's prescriptions; and
(f) correlating by the Network Administrator, using a programmable computer, the drug sample data set and the corresponding transaction data set.

10. The method of claim 9, wherein step (a) comprises receiving via a communication structure selected from the group consisting of telephone, telegraph, facsimile, global computer network, Internet, wide-area computer network, local-area computer network, electronic mail, and postal delivery; and steps (b), (c), and (e) comprise transmitting via a communication structure selected from the group consisting of telephone, telegraph, facsimile, global computer network, Internet, wide-area computer network, local-area computer network, electronic mail, and postal delivery.

11. The method of claim 9, wherein step (a) comprises receiving via Internet or eMail; and steps (b), (c), and (e) comprise transmitting via Internet or eMail.

12. The method of claim 11, wherein step (a) comprises receiving via Internet; and steps (b), (c), and (e) comprise transmitting via Internet.

13. The method of claim 9, further comprising (g) transmitting payment on behalf of the Network Administrator to the participating dispensary for (i) cost of the free drug sample dispensed, and (ii) a dispensing fee.

14. The method of claim 13, further comprising (h) transmitting payment on behalf of an entity underwriting the free drug sample promotion program to the Network Administrator for (i) the cost of the free drug sample dispensed, (ii) the dispensing fee, and (iii) a Network Administrator processing fee.

15. The method of claim 9, wherein in step (d)(i) the participating dispensary verifies that the patient whose prescription is to be filled meets eligibility requirements contained within the free drug data set.

16. A computer-implemented method for distributing and tracking free pharmaceutical samples, the method comprising
(a) receiving at a Network Administrator free drug sample data sets comprising identifiers for type of drug, dose, quantity, frequency, and program duration for free drug sample promotion programs from a plurality of different underwriters;
(b) transmitting from the Network Administrator to a patient a unique alphanumeric identifier for the patient;
(c) transmitting the free drug sample data sets received at the Network Administrator to a participating dispensary;
(d) filling at the participating dispensary a patient's prescription for any free drug sample being offered under one of the free drug sample promotion programs of step (a), wherein the participating dispensary
(i) confirms the free drug data set transmitted by the Network Administrator; and
(ii) records a corresponding transaction data set comprising the patient's unique alphanumeric identifier, and identifiers for type of free drug dispensed, amount of free drug dispensed, and date of dispensing the free drug;
(e) transmitting the corresponding transaction data set from the participating dispensary to the Network Administrator, wherein the patient's unique alphanumeric identifier remains unchanged for all of the patient's prescriptions;
(f) correlating by the Network Administrator, using a programmable computer, the drug sample data set and the corresponding transaction data set; and
(g) transmitting payment on behalf of the Network Administrator to the participating dispensary for (i) cost of the free drug sample dispensed, and (ii) a dispensing fee.

17. The method of claim 16, wherein step (a) comprises receiving via a communication structure selected from the group consisting of telephone, telegraph, facsimile, global computer network, Internet, wide-area computer network, local-area computer network, electronic mail, and postal delivery; and steps (b), (c), and (e) comprise transmitting via a communication structure selected from the group consisting of telephone, telegraph, facsimile, global computer network, Internet, wide-area computer network, local-area computer network, electronic mail, and postal delivery.

18. The method of claim 16, wherein step (a) comprises receiving via Internet; and steps (b), (c), and (e) comprise transmitting via Internet.

19. The method of claim 16, further comprising (h) transmitting payment on behalf of an entity underwriting the free drug sample promotion program to the Network Administrator for (i) the cost of the free drug sample dispensed, (ii) the dispensing fee, and (iii) a Network Administrator processing fee.

20. The method of claim 16, wherein in step (d)(i) the participating dispensary verifies that the patient whose prescription is to be filled meets eligibility requirements contained within the free drug data set.

21. The method of claim 16, wherein step (d) further comprises (iii) enrolling the patient in at least one underwriter's patient education program.
